(19) United States
(12) Patent Application Publication
(10) Pub. No.: US 2010/0019403 A1
(43) Pub. Date: Jan. 28, 2010

(54) PRODUCTION AND RECOVERY OF POLYMERIC MICRO- AND NANOPARTICLES CONTAINING BIOACTIVE MACROMOLECULES

(76) Inventors: Ana Catarina Beco Pinto Reis, Coimbra (PT); Francisco José Batista Veiga, Coimbra (PT); António José Ribeiro, Amarante (PT); Ronald James Neufeld, Sydenham (CA)

Correspondence Address: SUGHRUE MION, PLLC, 2100 PENNSYLVANIA AVENUE, N.W., SUITE 800, WASHINGTON, DC, 20037, US

(21) Appl. No.: 12/300,276

(22) PCT Filed: May 9, 2007
(86) PCT No.: PCT/PT2007/000019

§ 371 Date: Jun. 11, 2009

(30) Foreign Application Priority Data
May 10, 2006 (PT) PT 103476

(51) Int. Cl. B01J 13/18

(52) U.S. Cl. 264/4.7

(57) ABSTRACT

The present invention describes a method to encapsulate bioactive macromolecules, as example but not limited for, peptidic drugs, into polymeric particles sizing less than 10 μm of diameter Particle production is based on emulsification/internal gelation procedure and comprises a formation of a water-in-oil emulsion followed by solubilization of dispersed insoluble calcium complex triggering gelation of said polymer dispersed in internal phase, by ionic cross-linking with free calcium ions. Finally, resulting gelled particles dispersed in the oil phase are recovered by partition phases coupled with high speed centrifugation cycles. In this case, the present invention describes a precise methodology to recover said gelled polymeric particles after particle production and includes an addition of acetate buffer solution at predetermined pH, dehydrating agents and residual oil dissolvent agent, at predetermined concentration, followed by high speed centrifugation cycles. This method of production and recovery was applied to the macromolecule, insulin, and demonstrated that the bioactivity of said peptidic drug was preserved.

### FIELD OF THE INVENTIUON

The present invention describes a method to encapsulate bioactive macromolecules, as example but not limited to, peptidic drugs, into polymeric particles sizing less than 10 μm of diameter. Particle production is based on emulsification/internal gelation procedure and comprises a formation of a water-in-oil emulsion followed by solubilization of insoluble calcium complex and gelation of said polymer dispersed in the internal phase, by ionic cross-linking with released free calcium ions. Finally, gelled polymeric particles dispersed in the oil are recovered by partition phases coupled with high speed centrifugation cycles. In this case, the present invention describes a precise methodology to recover said polymeric particles after particle production which includes an addition of acetate buffer solution at predetermined pH, dehydrating agents and residual oil dissolvent agent, at predetermined concentration, followed by high speed centrifugation cycles.

### BACKGROUND OF THE INVENTION

Micro- and specially nanoencapsulation of drugs, specifically peptidic drugs, into polymeric particles has attracted considerable and growing interest as a technology and its advancement will not only stimulate the exploration of these new drug delivery systems but it will also lead to engineering revolutions and as a consequence, become a driving force for the therapy and diagnosis of numerous diseases in the current century.

Micro- and nanoencapsulation processes are applied on different industries, namely, food, printing, medical and cosmetic industries. In pharmaceutical industry, applications of micro- and nanoparticles are: elimination of flavors or odors, reduction or elimination of the gastric irritation or other secondary effects of some drugs, improvement in the flowability of powders, safe handling of toxic substances, protection against atmospheric agents (moistness, light, heat and/or oxygen), reduction of volatility, simultaneous administration of incompatibles drugs, conversion of liquids into solid form, dispersion of water-insoluble compounds in water or water-like media and finally, in the development of pharmaceutical forms for controlled, sustained and targeted release (Burgess & Hickey, 1995).

Micro- and nanoencapsulation of peptidic drugs involves polymeric particles formation namely micro- and nanoparticles. Micro- and nanoparticles are solid and spherical particles with diameter ranging 1 to 1000 μm and 1 nm to 1000 nm, respectively. They can be classified in micro- and nanocapsules in which the drug is confined to a cavity consisting of an inner core surrounded by a polymeric membrane with variable thickness; and micro- and nanospheres in which drugs may be homogenously dispersed and/or dissolved in polymeric matrix. In addition, it can be distinguished in policore or monocore micro- and nanocapsules, if core is divided or not, respectively. In addition, micro- and nanospheres can be homogenous or heterogenous, if encapsulant agent is dissolved or suspended (Aftabrouchard & Doelker, 1992).

Nanoparticles are receiving greater attention than microparticles for the delivery of therapeutic drugs including proteins, antigens, oligonucleotides and genes. Some studies have demonstrated a significant increase of intestinal absorption and consequently a higher bioavailability of encapsulanted drug.

Ideal method of micro- and nanoencapsulation must be simple, reproducible, fast, easy to scale-up and not highly dependent of the characteristics of solubility of the drug and polymer. During these three last decades, many methods of preparation of micro- and nanoparticles have appeared and classified in two large classes, accordingly particles formation involves or not reactions of polymerization of monomers into polymers, or from macromolecules or preformed polymers. Several polymers have been applied namely polyalkylcyanoacrylates (PACA), poly-L-glycolic acid (PLGA) or polyanhydrides and its derivatives. Despite their interest, toxicological problems may limit their applicability. In addition, these materials often present limitations for the administration of hydrophilic molecules such as peptides and proteins, since the polymers are mostly hydrophobic, whereas proteins and peptides are often hydrophilic. Therefore, the preparation of nanoparticles using more hydrophilic and naturally occurring materials has been explored.

Consequentently, the preparation of polymeric particles using hydrophilic polymers and natural origin has been recent and intensely explored (Douglas & Tabrizian, 2005). Until now, several methods has been considered. However, most involve organic solvents as dissolving agents of the encapsulated material and of the encapsulating polymer or other reagents that are incompatible to encapsulate many agents with biological nature.

In terms of the encapsulating polymer, it is common to use natural and biocompatible proteins or polysaccharides. Polysaccharides are strongly favoured, due to biocompatibility, biodegradability, hydrophility and protective properties. The hydrophilic nature of these polymers is highly advantageous, since they promote circulation time of drug in vivo, and they facilitate encapsulation of water-soluble macromolecules (Douglas & Tabrizian, 2005).

Natural polymers used in the encapsulation of biological products include: polysaccharides (alginate, chitin, chitosan and modified chitosan, dextran and modified dextran, dextrins and maltodextrins, pectins and modified pectins, agar, agarose, κ- e λ-carrageenan, gluco-mannan konjac, chondroitin sulfate, xanthana gum, arabic gum, gellan gum, starch and modified starch, cellulose and its derivatives); proteins (albumin, collagen and gelatin); other natural polymers such as rubber and silicates and its derivatives. Alginate has demonstrated numerous technological advantages over the other polymers listed.

Alginate is natural polysaccharide, biodegradable and biocompatible polysaccharide extracted from brown algae (Aslani & Kennedy, 1996). According to the Food and Drug Administration of USA, this polysaccharide is considered as atoxic compound and it is described as generally regarded as safe (GRAS). Chemically, alginate is composed by two types of uronic acid: guluronic acid (G) and mannuronic acid (M). Combination of those acids varies along alginate chain. This implies that three types of blocks may be found: homopolymeric M-blocks (M-M-M), homopolymeric G- blocks (G-G-G) and heteropolymeric, sequentially alternating MG-blocks (G-M-G-M)(Gacesa, 1988).

The solubility of alginate in water depends on the associated cations and pH. The viscosity of alginates in brown seaweed vary with the seasons and generally increases with maturation of the plant. There is a proportional relation between viscosity and G content.

Alginate forms a gel in the presence of divalent ions such as calcium and to a lesser extent in the presence of magnesium (Aslani & Kennedy, 1996). Gelation depends on the type of divalent ion and generally affinity increases in the following order: Mg²⁺<<Ca²⁺<Zn²⁺<Sr²⁺<Ba²⁺, Calcium ion is the most used since it is accessible and clinically safe. Structurally, calcium ions are located in the alginate polymer in electronegative cavities, being described in the literature as an egg-box model. Alginate gelation occurs at room temperature and under gentle formulation conditions, well suited for bioactive compounds. During alginate gelation, divalent cations bind preferentially to guluronic acid blocks in a highly co-operative manner. The size of the co-operative unit is reported to be more than 20 monomers (Walsh et al., 1996).

Generally, high guluronic content and homopolymer blocks lead to higher interaction between alginate and calcium, which results in a stronger and stable gel. However, in the emulsification formulation method, high G may result in premature gelation, resulting in larger beads, and more porous gels with larger size dispersions (Poncelet, 2001). In contrast, high M content produces smaller particles.

Alginate is a natural polymer, and is easily acessible worldwide, and is inexpensive. Over the last decades, suppliers of alginates have continuously appeared in the market place; the quality of the polymer is improving and alginates are now being sold partially or fully characterized in terms of its physicochemical properties.

Consequently, alginate has become the most widely used encapsulating polymer for biological materials including cells (Redenbaugh K & K A, 1986; Lim & Sun, 1980; Goosen et al., “Microencapsulation of Living Tissue and Cells,” Canadian Patent 1,215,922 (1982); Wang T, “Method and apparatus for producing uniform polymeric spheres,” U.S. Pat. No. 5,260,002 (1993)), citokins (Gombotz et al., “Methods and compositions for the oral delivery system, U.S. Pat. No. 5,451,411), yeasts and bacterias (Shiotani & Yamane, 1981; Larisch et al., 1994; Provost et al., 1985; Kalsta “Method of encapsulating biologically active substances with mucin, a capsule produced by the method, and a fodder containing such capsules”, U.S. Pat. No. 5,104,662; Lommi “Method using immobilized yeast to produce ethanol and alcoholic beverages”, U.S. Pat. No. 5,079,011), DNA (Alexakis et al., 1995; Quong & Neufeld, 1998) and others products (Canon, 1984; Burns et al., 1985).

The first process described to produce alginate beads involved polymer extrusion through a needle and at low speed of an alginate/immobilizant solution or suspension, dropwise into a solution of a divalent cation (typically calcium). The cation diffuses rapidly inward forming a Ca-polysaccharide gel. This extrusion method has at least three main drawbacks; the first being that size reduction is limited by nozzle diameter as well as the viscosity of the solution. Microparticles less than 500 mm are difficult to produce. The second drawback is that the procedure is not suitable for industrial scale-up as producing microparticles on a large scale requires a large number of nozzles to be operated simultaneously. Finally, microbeads tend to be teardrop-shaped due to drag forces following impact with the gelation bath.

Several techniques to solve the first problem have been developed such as the use of multiple needles, electrostatics, vibration, droplet propulsion from the needle tip by concentric airflow and liquid jet cutters. Atomizing spray techniques have also been investigated to produce smaller microspheres (less than 500 μm) at higher rates, but shearing effects in such a system could be harmful to many biological encapsulants and particles were not spherical.

Commercial encapsulators have emerged and appear popular amongst those working with droplet extrusion technologies. Using multiple needles, production rates at small and industrial scale are feasible but once again further large scale-up could be limited.

Some of the problems associated with droplet extrusion technologies may be avoided using emulsion/gelation or polymerization methods. For example, polymer/oil emulsions were chilled in cold water (Lacroix et al. 1990) or oil/polymer emulsions were extruded dropwise into CaCl2 solution (Lim and Sun 1980). The first procedure involved elevated temperatures which again may be incompatible with thermally labile material. As for the second method, particle size cannot be easily controlled and particles tend to aggregate before hardening properly.

A method to form alginate gel slabs was proposed in a procedure termed ‘internal gelation’ (Pelaez and Karel 1981). In industry, several methods were based on in situ gelation of alginate. One of the most well-known methods involves mixing sodium alginate with complexed calcium by the aid of ethylenediamine tetraacetic acid (EDTA) and using the slow hydrolysis n-glucono-β-lactone to lower the pH releasing the complexed calcium into the solution (Toft 1982). The main advantage of this method is that homogeneous alginate gels can be made over a wide pH-range. The by-products CO2 and n-gluconic acid are essentially non-toxic and for that reason, its use was limited.

The internal gelation concept was adapted toward the production of gel slabs, beads and microparticles, in an innovative procedure termed emulsification/internal gelation. Insoluble calcium micro-crystals dispersed into polysaccharide aqueous solution serve as an internal calcium source for the gelation reaction. This mixture is emulsified into an oil phase containing surfactant. Upon pH reduction or with chelator agents, calcium is released from calcium complex, triggering gelation to form Ca-polysaccharide. Fundamentally, calcium ions cross-link the polysaccharide residues and form polymeric network/matrix. This matrix can immobilize several compounds with many applications such as DNA, enzymes and proteins.

U.S. Pat. No. 4,053,627 describes a emulsification/gelation based method and consequent production of gel slabs which were applied to hormones administration in aqueous medium. This method produced polymeric spherical particles with diameter higher than 10 μm. The solubilization mechanism of calcium salt, calcium sulfate, was performed with solubilizant agent, sodium tripolyphosphate. Gelation time of the polymer was at least a period of 2 hours.

U.S. Pat. No. 4,400,391 describes a production method of macroparticles to encapsulate bioactive compounds. Method was based equally on the formation of an emulsion. The gelling agents used were barium and copper ions under the chloride form. It is known that for human and veterinary use, barium and copper ions present some problems making them unsuitable for application in therapeutical and clinical uses. Moreover, the diameter of macroparticles produced ranged from 0.1 to 6 millimeters.

U.S. Pat. No. 4,822,534 describes the emulsification/internal gelation based method with microsphere formation containing enzymes, natural oils, magnetite and plant cells. The method was based on the formation of an emulsion with low mechanical stirring speed, followed by solubilization of the calcium complex, through an organic acid. The microspheres were ionically cross-linked within a very short period of time. The resultant microsphere suspension was then partitioned into a calcium chloride solution. The recovery process occurs by gravitational sedimentation and the elimination of the residual oil was only partial and monitorized macrocospically. Resultant microspheres demonstrated diameters ranging from 80 to 300 μm with mean particle diameter of 150 μm.

U.S. Pat. No. 5,744,337 describes a method for preparation of microspheres by using alginate and/or gellan gum leading to microspheres with final diameter between 0.2 and 2000 μm. The calcium salt used was calcium sulphate dissolved in glycerol. The method was based on the formation of an emulsion by using vortex mixing during a short period of time, followed by solubilization of calcium complex, with etylenediaminetetraacetic acid (EDTA) or sodium polyphosphate. The resulting microsphere suspension was simply partitioned into water. The recovery process was by gravitational particle sedimentation and the elimination of the residual oil was only partial and monitored macrocospically. In operational terms, many differences were observed with the present invention such as: size of particles, type of oil and surfactant, ratio between aqueous and oil phases, homogenization speed rate, gelation time, the use of cryoprotectants to increase microsphere stability (U.S. Pat. No. 5,744,337) among others. In terms of recovery process, patent 5,744,337 does not describe the amount in percentage of recovered microspheres. In the same way, no size distribution in absolute and/or cumulative terms is described in the same document. Finally, it is important to note that this U.S. Pat. No. 5,744,337 describes as inconvenient, the presence of oil on the microsphere surface in U.S. Pat. No. 4,822,534, document; however, it does not make any reference to the elimination of the residual oil on their microspheres surface.

In all previous patents, polymeric particles demonstrated diameter higher than 10 μm with a polidispersed size distribution. Also, in all the documents described above, there was no mention of recovery yield or to the elimination of residual oil present on the particle surface. Finally, no reference was made to the encapsulation of peptidic drugs in the previous patents.

In terms of research publications (Chan, 2000; Esquisabel et al., 1997; Liu et al., 2004; Liu et al., 2002a; Poncelet, 2001; Poncelet et al., 1999; Poncelet et al., 1992; Poncelet et al., 1995; Quong & Neufeld, 1998; Quong et al., 1998; Tin et al., 1997; Vandenberg & NOUÈ, 2001; Walsh et al., 1996), there was is no reference to the use of the emulsification/internal gelation method, in terms of production of micro- and nanoparticles of alginate with diameter less than 10 μm containing bioactive macromolecules, as example but not limited to, peptidic drugs, and in terms of recovery process by partition phases followed by high speed centrifugation cycles.

The absorption of particles through the intestine is affected by a number of factors amongst which particle size is prominent (Saez et al., 2000). The critical particle size to enable absorption is still the subject of some debate but generally 10 μm appears as upper limit (Norris et al., 1998).

However, the great difficulty in obtaining polymeric particles with diameter less than 10 μm and using emulsification methods is mainly related to the recovery process. The high stability of the produced emulsion and the difficult elimination of the residual oil make the recovery process complex. The recovery process largely depends on particle diameter. Relatively large and rigid particles are readily separated from the dispersion by filtration or decantation (Arshady, 1990), but as the particle size decreases, the separation problems are magnified (Magenheim & Benita, 1991). Particles smaller than 10 mm are recovered by centrifugation (Arshady, 1990). In the present invention, the recovery process of polymeric particles through the exclusive use of centrifugation demonstrated a clear difficlty in recovery, being essential that this process be coupled with other strategies.

Insulin is anabolic hormone secreted by β-cells in the islets of Langerhans in the pancreas under pre-pro-hormone form. This pre-pro-hormone (is it really pre-pro or I have heard it described as proinsulin) is ruptured resulting in the insulin molecule composed of two amino acids chains A and B linked by two disulfide bridges. After synthesis, insulin directly spreads out through the portal vein into the liver, where it exerts its metabolic effect. The main function of insulin is associated with the regulation of hiperglicemics hormones and to the homeostases of glycemia levels. When insulin production/action is inadequate or completely absent, the illness Diabetes Mellitus occurs, whose exogenous treatment with insulin is normally complement or mandatory. The main goal of exogenous administration of insulin is related to obtaining the same plasmatic levels of the bimodal physiological secretion in healthy individuals. Diabetes Mellitus is characterized by high glucose blood levels and some cases by ketoacidosis episodes. The common therapy consists of the parenteral administration of insulin, specially by the subcutaneous route (s.c.). Generally, diabetic patients have to administer exogenous insulin a few times throughout the day to obtain good glycemic control. Pharmaceutical technology studies are focused on two different aspects: prolonging insulin action in order to reduce the number of doses or searching for other routes of insulin administration. In the first case, many advances have appeared but in the second case technological advances are elusive. The actual and only route of insulin administration remains the s.c. route. The s.c. administration of insulin leads to numerous secondary effects and it is followed by associated physicosocial disabilities. To obtain an oral dosage form of insulin would be a great contribution to the treatment of the Diabetes Mellitus, and even it does not replace the parenteral insulin therapy, it could complement it. In addition to an increase in patient compliance to the therapy, oral insulin would mimic all aspects of the physiological insulin present in normal individuals. However, susceptibility to proteolytic enzymes throughout the gastrointestinal tract, as well as weak intestinal insulin permeability and insulin physicochemical instability make this task difficult.

Several strategies to obtain oral insulin have been developed such as: protease inhibitors (Fujii et al., 1985; Morishita et al., 1993a; Morishita et al., 1993c; Yamamoto et al., 1994), absorption promoters (Fasano & Uzzau, 1997; Mesiha et al., 1994; Schilling & Mitra, 1990; Scott Moncrieff et al., 1994; Shao et al., 1994; Shao et al., 1993; Touitou & Rubinstein, 1986; Uchiyama et al., 1999), chemical modification (Hashizume et al., 1992; Asada et al., 1995; Hashimoto et al., 2000; Hinds et al., 2005; Still, 2002), liposomes (Patel & Ryman, 1976; Iwanaga et al., 1999; Iwanaga et al., 1997; Kim et al., 1999; Zhang et al., 2005), cells (Al Achi & Greenwood, 1993a; Al Achi & Greenwood, 1993b; Al Achi & Greenwood, 1994), emulsions (Cournarie et al., 2004; Ho et al., 1996; Matsuzawa et al., 1995; Silva-Cunha et al., 1997), enteric coatings (Hosny et al., 1995; Morishita et al., 1993b; Touitou & Rubinstein, 1986; Trenktrog et al., 1996), colon target delivery (Saffran et al., 1986; Tozaki et al., 1997) or ileum target delivery (McPhillips et al., 1997), conjugates (Shah & Shen, 1996; Xia et al., 2000), bioadhesive systems (Aiedeh et al., 1997; Mathiowitz et al., 1997), polymeric particles(Aboubakar, 1999; Damgé et al., 1988; Lowe & Temple, 1994; Oppenheim et al., 1982; Cui et al., 2004; Morcol. et al., 2004; Pan et al., 2002; Pinto-Alphandary, 2003; Radwan, 2001; Watnasirichaikul et al., 2002) or combination of strategies (Carino et al., 2000; Kimura et al., 1996; Manosroi & Manosroi, 1997; Morishita et al., 2000; Mesiha & Sidhom, 1995; Saffran et al., 1997; Ziv et al., 1994).

### DISCLOSURE OF THE INVENTION

The present invention proposes an encapsulation method for bioactive macromolecules, as example but not limited to, peptidic drugs, into alginate particles, sizing less than 10 μm of diameter, by using emulsification/internal gelation procedure and a recovery process by using partition phases coupled with high speed centrifugation cycles.

Micro- and nanoparticles of alginate with diameter less than 10 μm, containing insulin, will be applied to oral therapy of Diabetes Mellitus treatment.

The present invention also describes a methodology to recover micro- and nanoparticles of alginate with diameter less than 10 μm and containing bioactive macromolecules, as example but not limited to, peptidic drugs, by using partition phases through a recovery system which comprises a buffer solution at predetermined pH, dehydrating solvents, residual oil dissolvent agent followed high speed centrifigation cycles.

Removal of dehydrating solvents and residual oil dissolvent agent is greatly facilitated by the fact that all solvents applied in the recovery system are highly volatile. Their removal was readily achieved during all recovery and lyophilization processes.

The model peptidic drug to show the effects and to characterize the process described in the present invention is human insulin which synthetized commercially by recombinant DNA techniques.

An illustrative but not limiting example of the present invention describes a new production method with gentle formulation materials and conditions to encapsulate macromolecules into micro- and nanoparticles with diameter less than 10 μm, containing insulin, in order to orally administer the said peptidic drug, and describes a new recovery process after particle production. Protein bioactivity is also analyzed after the formulation and recovery processes.

### BRIEF DESCRIPTION OF THE DRAWINGS

This invention can additionally be illustrated through the drawings and photographs that follow:

FIG. 1 describes the laboratorial equipment that can be used in the development of this invention.

FIG. 2 describes an illustrative schema of the proposed mechanism of alginate gelation with calcium ions.

FIG. 3 describes the absence of residual oil after the recover process of the micro- and nanoparticles of alginate monitored by optical microscopy.

FIG. 4 is a graphical representation of size distribution in number (discontinous line) and in volume (continuous line) of the micro- and nanoparticles of alginate produced by emulsification/internal gelation and recovered by addition of acetate buffer solution at predetermined pH, dehydrating agents and an residual oil dissolvent agent, at adequate concentration, followed by high speed centrifugation cycles.

FIG. 5 is a graphical representation of the percentage of recovery yield (simple bars) and encapsulation efficiency (filled bars) of the micro- and nanoparticles of alginate produced by the emulsification/internal gelation method and recovered by addition of acetate buffer solution at predetermined pH, dehydrating agents and residual oil dissolvent agent, at adequate concentration, high speed centrifugation cycles.

FIG. 6 is a graphical representation of the insulin bioactivity by measuring hypoglycaemic effect along time, after s.c. administration of insulin released from micro- and nanoparticles of alginate produced by emulsification/internal gelation method and recovered by addition of acetate buffer solution at predetermined pH, dehydrating agents and residual oil dissolvent agent, at adequate concentration, followed by high speed centrifugation cycles: empty particles (-▴-), dissolution medium (PBS) (-x-), without treatment (-Δ-), (--□--) non-encapsulated insulin 1 IU/kg, (--o--)non-encapsulated insulin 4 IU/kg, (-▪-) insulin encapsulated and released from particles 1 IU/kg, and finally, insulin encapsulated and released from particles 4 IU/kg(--). Each value represents mean±S.E.M. with n=6 per group.

### SUMMARY OF THE INVENTION

The present invention describes a new method to encapsulate bioactive macromolecules, as example but not limited to, peptidic drugs, into polymeric particles sizing less than 10 μm of diameter. Particle production is based on emulsification/internal gelation procedure and comprises a formation of a water-in-oil emulsion; solubilization of insoluble calcium complex and gelation of said polymer dispersed in internal phase by ionic cross-linking with free calcium ions. Finally, gelled particles dispersed in oil suspension are recovered by partition phases which comprise an addition of acetate buffer solution at specific pH, dehydrating agents and and dissolving agent of the residual oil, at adequate concentration, coupled with high speed centrifugation cycles.

### DETAILED DESCRIPTION OF INVENTION

The optimal formulation method should be simple, reproducible, rapid, easy to scale-up and should be applied using natural and biodegradable materials. It is equally important that the method chosen be economically advantageous in terms of recovery yield, and in a more particular sense, able to efficiently encapsulate the chosen drug. It is also necessary that said method not modify and/or damage the physicochemical characteristics of the encapsulated drug and not affect its bioactivity throughout the entire process.

One method with those characteristics should substitute traditional methods of production of micro- and nanoparticles which generally are based in reactions of polymerization of monomers or based on preformed monomer of synthetic origin, preventing the typical disadvantages associates to each one of them.

The present invention describes one method to produce polymeric micro- and nanoparticles sizing less than 10 μm of diameter and containing bioactive macromolecules, as for example but not limited to, peptidic drugs, by emulsification/internal gelation method from natural and biodegradable polymer followed by a recovery method which comprises an addition of a recovery system containing acetate buffer solution at predetermined pH, dehydrating agents and an residual oil dissolvent agent, in adequate concentration, followed by high speed centrifugation cycles.

The first claim of the present invention is an encapsulation method for macromolecule sizing less than 10 μm of diameter by using emulsification/internal gelation technique, in accordance with following the steps:
a) formation of an water-in-oil emulsion, in adequate composition, temperature, mechanical stirring rate and from the mixture of an aqueous phase, containing encapsulating polymer, the macromolecule and an insoluble salt of divalent ion which is gelling agent of the polymer, dispersed into an oil phase, containing a mineral oil and surfactant; and
b) solubilization of the insoluble salt of divalent ion through a pH-dependent mechanism followed by polymer gelation through ionic cross-linking with the free divalent ions.

Of preference, the step a) previously related is carried through the following sub-steps:
a.1) dissolution of the encapsulating polymer in distilled water, in adequate concentration, under orbital agitation and according to predetermined operational conditions of time and temperature;
a.2) addition of the macromolecule to the aqueous solution of the encapsulating polymer, in adequate concentration, under gentle manual agitation and according to predetermined operational conditions of temperature;
a.3) introduction in a reactor, of a mineral oil and a surfactant, in liquid state, in adequate concentration, and according to predetermined operational conditions of temperature;
a.4) preparation of an external phase, oil phase, containing a mineral oil and surfactant, in liquid state, in adequate concentration according to predetermined operational conditions of time, mechanical stirring rate and temperature;
a.5) preparation of an internal phase, aqueous phase, through the addition of an insoluble salt of divalent ion to the aqueous solution which contains the encapsulating polymer and the macromolecule, in adequate concentration, under gentle manual agitation according to predetermined operational conditions of temperature;
a.6) the transference of the aqueous phase to the reactor which contains the oil phase in predetermined operational conditions of time, mechanical stirring rate and temperature; and
a.7) formation of a water-in-oil emulsion of the mixture of the two phases, aqueous and oil, in predetermined operational conditions of time, mechanical stirring rate and temperature.

Of preference, step b) previously related is carried through the following sub-steps:
b.1) slow addition, drop-by-drop, of an oil soluble organic acid in adequate concentration, which is dispersed in a predetermined volume of a mineral oil to the water-in-oil emulsion;
b.2) solubilization of the insoluble salt of the divalent ion through a pH-dependent mechanism and according to predetermined operational conditions of time, mechanical stirring rate and temperature; and
b.3) gelation of the encapsulating polymer by ionic cross-linking with the free divalents ions in predetermined operational conditions of time, mechanical stirring rate and temperature.

The second claim of this invention, after encapsulation of said macromolecules into said polymeric particles, relates to the respective recovery process through partition of phases followed by high speed centrifugations cycles, in accordance with the following steps:
c) partition of phases of the water-in-oil emulsion through a recovery system which comprises acetate buffer solution at predetermined pH, dehydrating agents and a residual oil dissolvent agent in adequate concentration.
d) High speed centrifugation of the partitioned water-in-oil emulsion in order to recover total or great part of the particles polymeric sizing less than 10 μm of diameter.

Of preference, the step c) previously related is carried through the following sub-steps:
c.1) addition of a recovery system containing acetate buffer solution at predetermined pH with dehydrating agents and a residual oil dissolvent agent, in adequate concentration, to the reactor which contains the oil dispersed particle suspension consisting of gelled polymer, in order to partition of phases of said particle dispersion in predetermined operational conditions of time, mechanical stirring rate and temperature;
c.2) transference of the partitioned oil dispersed particles to a first container with predetermined capacity and under orbital agitation in predetermined operational conditions of time, mechanical stirring rate and temperature;
c.3) Partitioned particle oil dispersion, contained in the first container, was settled down in operational conditions predetermined of time and temperature;
c.4) removal by vacuum of the said partitioned particle in oil dispersion, to a second container with predetermined capacity, followed by addition of acetate buffer solution at predetermined pH, in adequate concentration, and according to predetermined operational conditions of temperature;
c.5) transference of polymeric particles, sizing less than 10 μm of diameter and contained in the first container, to a third container with predetermined capacity followed by settling down at predetermined temperature.

Of preference, the step d) previously related is carried through the following sub-steps:
d.1) orbital agitation at predetermined speed rate of the said partitioned water-in-oil with acetate buffer solution at predetermined pH followed by high speed centrifugation applying a predetermined centrifugal force and predetermined operational conditions predetermined of temperature and time;
d.2) elimination of residual oil by decantation;
d.3) recovery of high speed centrifuged polymeric particles, sizing less than 10 μm of diameter and containing bioactive macromolecules, and its transference to a third container;
d.4) the repetition of the following procedures: removal by vaccum the top of the partitioned water-in-oil emulsion; transference of the partitioned particle in oil dispersion to the second container with a predetermined capacity;

addition of acetate buffer solution in predetermined pH, in adequate concentration;

orbital agitation at a predetermined speed rate followed by high speed centrifugation with predetermined centrifugal force, temperature and time until obtaining the total or main part of the polymeric particles sizing less than 10 μm of diameter;
d.5) the recovery of the gelled polymeric particles after being centrifuged, sizing less than 10 μm of diameter and containing bioactive encapsulated macromolecules, and its transference to a third container.
d.6) high speed centrifugation of gelled polymeric particles, sizing less than 10 μm and containing bioactive encapsulated macromolecules and contained in third container, applying predetermined centrifugal force and time and until residual oil is removed and polymeric particle transference to a fourth container;
d.7) settling of gelled polymeric particles, sizing less than 10 μm of diameter and containing bioactive encapsulated macromolecules and contained in the fourth container, suspended in acetate buffer solution, in adequate concentration, and predetermined pH and according to predetermined operational conditions of temperature.

The protein model of the macromolecule is drug, which is applied to human and/or veterinary use.

The protein model of the peptidic drug is insulin with human origin which is commonly administered in Diabetes Mellitus treatment.

The future route of administration of said pharmaceutical form will be oral administration as hypoglycaemic agent.

The polymer in accordance with this invention is linear, of hydrophilic nature and natural origin.

Of preference, the linear polymer, of hydrophilic nature and natural origin, is selected between oligosaccharides or polysaccharides, such as alginic acid and its derivatives, chitin, chitosan and modified chitosan, dextran and modified dextrans, dextrins and maltodextrins, pectins and modified pectins, agar, agarose, κ- e λ-carrageenans, konjac glucomannan, chondroitin sulfate, xantana gum, arabic gum, gellan gum, starch and modified starch, cellulose and its derivatives, proteins such as albumin, collagen and gelatin or natural polymer such as rubber and silicas and its derivatives.

In preference, the said polymer is alginate under sodium salt form.

In preference, the said divalent ion which causes polymer gelation is calcium under the carbonate form.

### Experimental Part

In the preparation of the water-in-oil emulsion the ratio in volume, between the aqueous phase and oil phase, is preferentially between 20:80 to 50:50, and specifically about 50:50.

In accordance with the invention, normally a recovery system is used that contains in adequate concentration: acetate buffer solution at pH 4.5 prepared following United States Pharmacopeia (USP XXVIII) as recovery medium of particles, acetone and isopropanol as dehydrating solvents and finally, n-hexane as residual oil dissolvent agent.

Generally, a centrifugal force between 7 500×g and 20 000×g, preferentially about 12 500×g, is applied to the recovery process of gelled polymeric particles sizing less than 10 μm of diameter and containing bioactive macromolecules.

The operating temperature is normally below 40° C., and specifically, below 25° C., but can vary or remain constant during the same process or be reduced by 4° C., or less, in the case of settling and during the high speed centrifugation.

The dissolution time of polymer is placed preferential between 4 and 12 hours, and specifically between 6 and 8 hours, and the orbital agitation is set, in preference, between 50-200 rpm.

The preparation of the oil phase occurs normally between 5 and 40 minutes, preference about 15 minutes under mechanical agitation at 200-800 rpm, preference about 400 rpm.

The emulsification time is placed normally between 5 and 40 minutes, preference about 15 minutes under mechanical agitation at 800-3000 rpm, preference about 1600 rpm.

The gelation time normally ranges between 30 minutes and 2 hours, with preference about 60 minutes under mechanical agitation at 800-3000 rpm, preference about 1600 rpm.

The time of addition of the recovery system is placed normally between 1 and 5 minutes, with preference about 2 minutes under mechanical agitation at 200-800 rpm, preference about 400 rpm.

The time of orbital agitation after the addition of the recovery system is placed normally between 5 and 20 minutes, with preference about 10 minutes, with a mechanical agitation of 50-200 rpm, with preference about 100 rpm.

Partitioned particle-oil dispersion is settle down normally between 10 and 48 hours, with preference between 20- 24 hours.

The time of agitation of the water-in-oil emulsion, partitioned and removed by vaccum, with the buffer solution is placed generally between 5 and 20 minutes, with preference of about 10 minutes, under orbital agitation at 50-200 rpm, with preference about 100 rpm.

The time of high speed centrifugation of the partitioned water-in-oil emulsion is placed generally between 5 and 20 minutes, with preference about 10 minutes, with centrifugal force of 7500×g to 20 000×g, with preference about 12 500×g.

The containers used during all the process should have a minimum capacity of 300 mL, advantageously at least 600 mL.

The bioactivity of peptidic drug was also tested after its encapsulation into polymeric particles, sizing less than 10 μm diameter and produced by emulsification/internal gelation method and recovered by partition of phases followed of high speed centrifugation cycles.

The encapsulation efficiency is at least 70% of bioactive macromolecules of hydrophilic character into polymeric particles sizing less than 10 μm of diameter.

The recovery yield is at least 65% of bioactive macromolecules into polymeric particles, sizing less than 10 μm of diameter, through an addition of acetate buffer solution at predetermined pH with dehydrating agents and residual oil dissolvent agent, in adequate concentration, followed by high speed centrifugation cycles.

### Examples

Several methods to encapsulate bioactive, as for example but not limited to, peptidic drugs, into polymeric particles sizing less or higher than 10 μm of diameter, are described (Kreuter, 1992; Quintanar-Guerrero et al., 1998), but the main part of those methods involve synthetic materials as encapsulating polymer and organic solvents as dissolvent agents of the drugs. The present invention describes one method to encapsulate bioactive macromolecules, as for example but not limited to, peptidic drugs, into polymeric particles produced from a natural polymer. In addition, the present invention describes a transposition of the emulsification/internal gelation method to produce polymeric particles sizing less than 10 μm in diameter and containing peptidic drugs. This method transposition leads to several difficulties in terms of recovery process. The present invention describes an adequate methodology and is based on partition phases which comprise a recovery system containing acetate buffer solution at predetermined pH, dehydrating agents and residual oil dissolvent agent, in adequate concentration, followed by high speed centrifugation cycles.

### Preparation Example

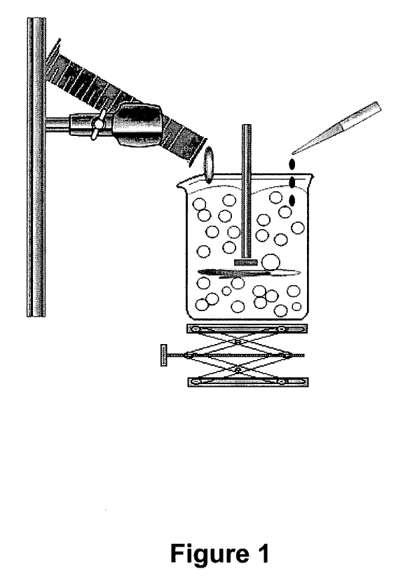

Dissolve alginate (1 g) into 50 mL of distilled water under orbital agitation (100 rpm) during 6-8 hours at room temperature. Insulin (10 mL, 1000 UI) is slowly added to the solution of alginate. Separately, mineral or paraffin oil, (50 mL) is mixed with sorbitan monooleate (Span 80, 1.5 mL) in a reactor as illustrated in FIG. 1.

An external oil phase, containing paraffin oil and sorbitan monooleate, at room temperature, is prepared under mechanical stirring rate at 400 rpm during a period of 15 minutes. An internal aqueous phase is prepared by adding sonicated calcium carbonate (8.3 mL of aqueous solution prepared at 5% w/v) to the aqueous solution of alginate and insulin at room temperature (mass relation between calcium and alginate is 16.7%, w/w.

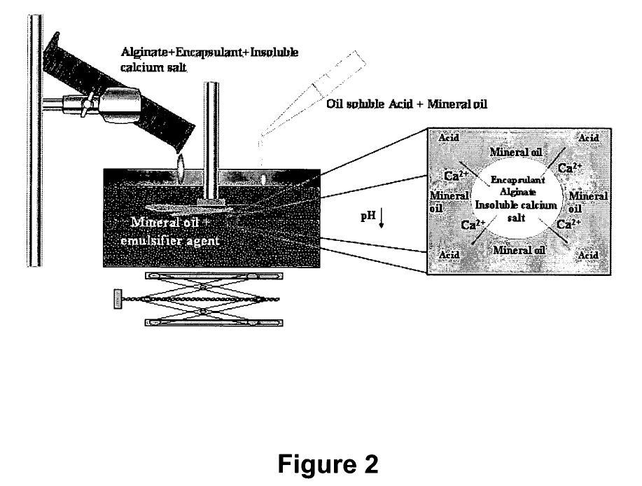

The aqueous phase is transferred to the oil phase, which was contained in the reactor, under continous mechanical stirring rate at 1600 rpm, during 15 minutes at room temperature and, consequently, an water-in-oil emulsion is formed according to FIG. 1. Then, insoluble calcium salt is solubilized through a slow addition, drop-by-drop, and under continous mechanical stirring rate at 1600 rpm, of a liposoluble organic acid dispersed (glacial acetic acid; 830 μL), in 20 mL of paraffin oil, during 60 minutes at room temperature, in order to produce a complete polymer gelation by cross-linking with calcium ions. Solubilization mechanism is illustrated in FIG. 2 and described by following steps (1) and (2):

2H⁺+CaCO₃ →Ca²⁺+H₂O+CO₂ (1)

Ca²⁺+2Na⁺Alg^{-Ca}²⁺(Alg⁻)₂+2Na⁺ (2)

According to this mechanism, there are two main steps after acid diffusion through the water-oil interface (Liu et al., 2002b). Protons (H+) are spread out in the aqueous phase of the gel. In this aqueous phase of the gel, calcium ions are uniformly located and are released in situ, leading to alginate gelation and concomitant entrapment of peptidic drug within the polymeric matrix.

A mixture (100 mL) of acetate buffer solution at pH 4.5 (70 mL) with dehydrating agents acetone (15 mL) and isopropanol (10 mL) and 5 mL of a residual oil dissolvent agent, n-hexane, is added to the reactor at 400 rpm, during a period of 2 minutes and at room temperature in order to produce the partition of phases of the particle-in-oil dispersion. Partitioned particle-in-oil dispersion is transferred to a first container of 600 mL, followed by orbital agitation at 100 rpm during 10 minutes and at room temperature. Partitioned particle-in-oil dispersion is settled down in the first container during 20-24 hours at temperature of 4° C. Partitioned particle in oil dispersion is removed by vaccum followed by its transference to a second container of 600 mL.

A solution of acetate buffer at 4.5 (50 mL) is added to the partitioned particle-in-oil dispersion contained in a second container and it is stirred under orbital agitation at 100 rpm and high speed centrifuged applying centrifugal force 12500×g during 10 minutes at temperature of 4° C. Recovered polymeric particles, sizing less than 10 μm of diameter, are transferred to a third container with 600 mL of capacity and settled down at temperature of 4° C.

Polymeric centrifuged particles, sizing less than 10 μm of diameter, containing insulin are transferred to the third container.

This procedure is repeated 3 times with the following steps: surface oil removal by decantation; removal by vaccum of the top part of the partitioned particle-in-oil dispersion and transferring it to second container with predetermined capacity; addition of acetate buffer solution at pH 4.5 (50 mL); orbital stirring at 100 rpm during 10 minutes and finally, high speed centrifugation applying centrifugal force 12 500×g during 10 minutes and at temperature of 4° C. until all or a large part of polymeric particles are recovered, sizing less than 10 μm of diameter.

Polymeric gelled centrifuged particles, sizing less than 10 μm of diameter, containing insulin, are transferred to a third container. Then, these particles are centrifuged applying centrifugal force of 12 500×g during 10 minutes and at 4° C. until, residual oil is removed and its elimination monitored by optical microscopy. Finally, oil-free particles, sizing less than 10 μm of diameter, are transferred to a fourth container.

Gelled polymeric particles, sizing less than 10 μm in diameter, contained in a fourth container and suspended in acetate buffer solution pH 4.5 (50 mL) at 4° C. are frozen and lyophilized at 0° C. during a minimum period of 48 hours. After lyophilization, gelled polymeric particles, sizing less than 10 μm of diameter, weighed and recovery yield is calculated. Recovery yield was assessed by measuring the ratio between the recovered lyophilized particles and the initial mass of solids.

### Quantification of Encapsulation Efficiency

In order to quantify encapsulation efficiency of insulin, drug release from lyophilized polymeric particles was required. A certain amount of lyophilized polymeric particles (10 mg) were incubated in 10 mL hydrochloric acid buffer at pH 1.2 (USP XXVIII) under magnetic stirring (100 rpm, 2 h). Aliquots of 1.5 mL were collected and centrifuged. The supernatant containing released insulin was collected to be assayed. The remaining polymeric particles were transferred into a phosphate buffer at pH 6.8 (USP XXVIII) under magnetic stirring (100 rpm, 1 h). Aliquots of 1.5 mL were collected, centrifuged, and the supernatant containing released protein was collected for protein quantification by spectrophotometry using calorimetric method with wavelength at 595 nm. The ratio between total amount of released insulin and total amount of insulin initially added is assigned as encapsulation efficiency value.

### Biological Trials

Insulin bioactivity was tested, after production and recovery processes, in 7 groups of male wistar rats, in total 42 animals, weighing 250-300 g with 3 months of age. All animal procedures were reviewed and approved by the committee for animal research according to Portuguese Law (DL no. 197/96) and the Institutional European Guidelines (no. 86/609)and in authorized laboratory by Direccão Geral de Veterinária.

Table 1 describes all tested formulations which were produced by emulsification/internal gelation method and recovered by recovery process described.

TABLE 1
Formulations and different treatment tested by bioactivity test.

| Animal groups | Treatment |
|---|---|
| I | Empty polymeric particles |
| II | Dissolution medium (PBS) |
| III | Fasting effect-no treatment |
| IV | Non-encapsulated insulin 1 IU/kg |
| V | Non-encapsulated insulin 4 IU/kg |
| VI | Insulin encapsulated and released |
| | from polymeric particles 1 IU/kg |
| VII | Insulin encapsulated and released |
| | from polymeric particles 4 IU/kg |

Before diabetes induction, animals were fasted 16-19 hours with free access to water. An extemporanea solution of streptozotocin (20 mg/mL) was prepared by dissolving this chemical in citrate buffer at pH 4.5. Before intraperitoneal injection (i.p.)of streptozotocin, glycemia levels of all animals were assessed. The glycemia levels had been determined according to glucose oxidase method. These values of glycemia had been considered as basal values. Each animal received single dose of streptozotocin at 50 mg/kg by i.p. During the first 24 hours, rats were given 5% glucose to prevent hypoglycaemia and loss of animals. Rats with frequent urination, loss of weight, and blood glucose levels higher than 250 mg/dL with fasting period of 12-16 hours were selected and randomly divided into seven groups as outlined in Table 1. Before testing, animals were fasted overnight with free access to water.

Polymeric particles containing insulin were incubated in phosphate buffer at pH 7,4 under magnetic stirring at 20° C. during a period of 2 hours. Same procedure was performed for all formulations. After insulin release, samples were centrifuged (12 500×g, 10 minutes at 4° C.). Then, supernatant was filtered through filter with pore size of 0.45 μm. Filtrate was collected and insulin concentration was assessed by high performance liquid chromatogram (HPLC).

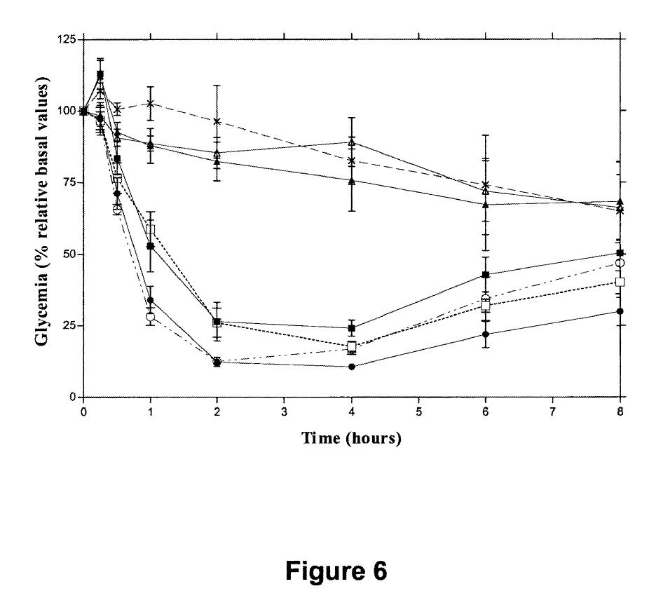

All animals received by s.c. single dose of different formulations at volume 1 mL/kg, according to Table 1. Blood samples were taken from the tip of the tail vein and measured and plotted as hypoglycaemic effect (% relative basal values) versus time according to FIG. 6.

### Results

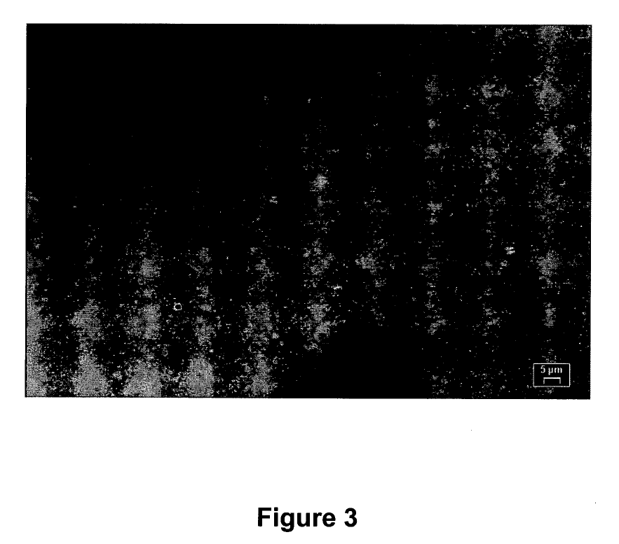

Micro- and nanoparticles, containing insulin, and produced by emulsification/internal gelation method and recovered by previous recovery process did not show residual oil as shown in FIG. 3.

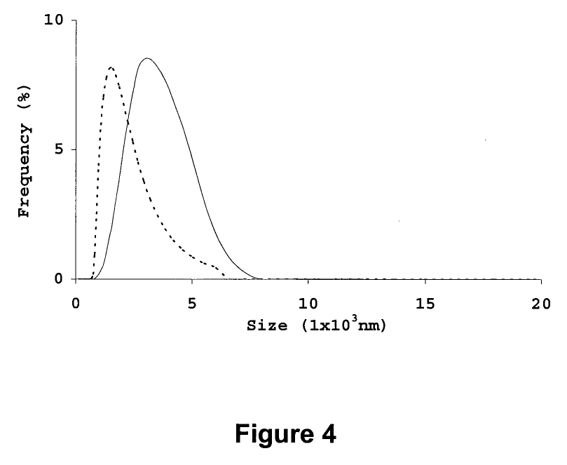

Micro- and nanoparticles, containing insulin, and produced by emulsification/internal gelation method and recovered by previous recovery process demonstrated a uniform size distribution and monomodal population as shown in FIG. 4. This figure confirms the presence of polymeric particles with mean diameter less than 10 μm. In cumulative values, 100% of polymeric particles demonstrated diameter less than 10 μm.

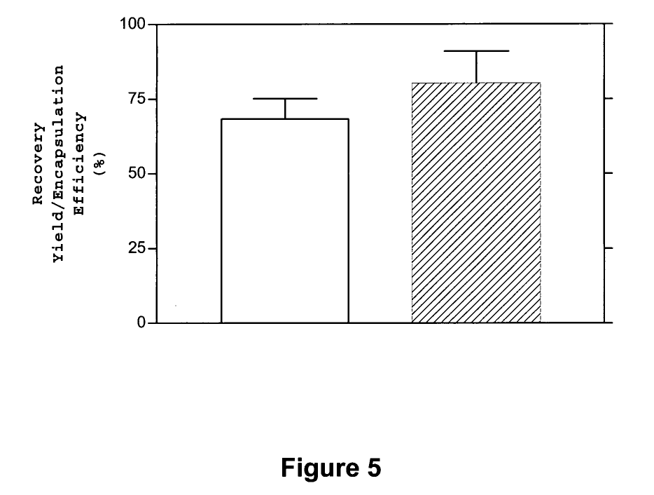

Micro- and nanoparticles, containing insulin, and produced by emulsification/internal gelation method and recovered by previous recovery process demonstrated a recovery yield around 68.57±1.3% relative to initial mass of solids as represented in FIG. 5.

Micro- and nanoparticles, containing insulin, and produced by emulsification/internal gelation method and recovered by previous recovery process demonstrated an encapsulation efficiency around 80.37±10.6% as shown in FIG. 5.

### Biological Trials

Statistical evaluation was performed with a one-way ANOVA followed by a Dunnett multiple comparison test. A P<0.05 was taken as the criterion of significance in relation to the group effect, group III. Data was processed by Statview program, Macintosh.

A significant difference was observed between groups tested with insulin in relation to group III with p<0,001. However, between the insulin formulations any difference was observed and then it can be concluded that insulin bioactivity was totally preserved after the process of encapsulation and recovery previously described in the present invention.

The preservation of peptidic drug bioactivity was demonstrated, more specifically insulin, through the confirmation of its hypoglycaemic effect after its encapsulation into micro- and nanoparticles of alginate produced by emulsification/internal gelation method and recovered by the recovery process described above.

### PATENT REFERENCES

Canadian Patent 1,215,922—M. F. A. Goosen et al.
U.S. Pat. No. 5,451,411—Gombotz et al.
U.S. Pat. No. 5,260,002—Wang
U.S. Pat. No. 5,104,662—Kalsta
U.S. Pat. No. 5,079,011—Lommi
U.S. Pat. No. 4,053,627—Scher
U.S. Pat. No. 4,400,391—Connick et al.
U.S. Pat. No. 4,822,534—Lencki et al.
U.S. Pat. No. 5,744,337—Price et al.

### OTHERS REFERENCES

Aboubakar, M., 1999. Physico-chemical characterization of insulin-loaded poly(isobutylcyanoacrylate) nanocapsules obtained by interfacial polymerization. International Journal of Pharmaceutics 183, 63-66.
Aftabrouchard, D. & E. Doelker, 1992. Preparation methods for biodegradable microparticles loaded with water- soluble drugs. S. T. P. Pharma Sciences 2, 365-380.
Aiedeh, K., E. Gianasi, I. Orienti & V. Zecchi, 1997. Chitosan microcapsules as controlled release systems for insulin. Journal of Microencapsulation 14, 567-576.
Al Achi, A. & R. Greenwood, 1993a. Human insulin binding to erythrocyte-membrane. Drug Development of Industrial Pharmacy 19, 673-684.
Al Achi, A. & R. Greenwood, 1993b. Intraduodenal administration of biocarrier-insulin systems. Drug Development Industrial of Pharmacy 19, 1303-1315.
Al Achi, A. & R. Greenwood, 1994. Human insulin absorption from the intestine in diabetic rats. Drug Development of Industrial Pharmacy 20, 2333-2339.
Alexakis, T., D. K. Boadi, D. Quong, A. Groboillot, I. O'Neill, D. Poncelet & R. J. Neufeld, 1995. Microencapsulation of DNA within alginate microspheres and crosslinked chitosan membranes for in vivo application. Applied Biochemistry and Biotechnology 50, 93-106.
Arshady, R., 1990. Albumin microspheres and microcapsules: Methodology of manufacturing techniques. Journal of Controlled Release 14, 111-131.
Asada, H., T. Douen, M. Waki, A. Yamamoto, S. Muranishi & et al., 1995. Absorption characteristics of chemically modified-insulin derivatives with various fatty acids in the small and large intestine. Journal Pharmaceutical Sciences 84, 682-687.
Aslani, P. & R. A. Kennedy, 1996. Studies on diffusion in alginate gels. I. Effect of cross-linking with calcium or zinc ions on diffusion of acetaminophen. Journal of Controlled Release 42, 75-82.
Burgess, D. J. & A. Hickey, 1995. Microsphere technology and applications. In: J. Swarbrick and J. C. Boylan (Editor), Encyclopedia of pharmaceutical technology. Marcel Dekker, N.Y., pp. 1-29.
Burns, M. A., G. I. Kvesitadze & D. J. Graves, 1985. Dried calcium alginate/magnetite spheres: A new support for chromatographic separations and enzyme immobilization. Biotechnology & Bioengineering 27, 137-145.
Canon, K., 1984. Electrostastic image development toners, Japan, pp. 59170853.
Carino, G. P., J. S. Jacob & E. Mathiowitz, 2000. Nanosphere based oral insulin delivery. Journal of Controlled Release 65, 261-269.
Chan, L. W., 2002. Production of alginate microspheres by internal gelation using emulsification method. International Journal of Pharmaceutics 242, 259-262.
Cournarie, F., V. Rosilio, M. Cheron, C. Vauthier, B. Lacour, J.-L. Grossiord & M. Seiller, 2004. Improved formulation of w/o/w multiple emulsion for insulin encapsulation. Influence of the chemical structure of insulin. Colloid Polymer Science 282, 562-568.
Cui, F., L. Zhang, J. Zheng & Y. Kawashima, 2004. A study of insulin-chitosan complex nanoparticles used for oral administration. Journal of Drug Development Sciences Technologies 14, 435-439.
Damgè, C., C. Michel, M. Aprahamian & P. Couvreur, 1988. New approach for oral administration of insulin with polyalkylcyanoacrylate nanocapsules as drug carrier. Diabetes 37, 246-251.
Douglas, K. L. & M. Tabrizian, 2005. Effect of experimental parameters on the formation of alginate-chitosan nanoparticles and evaluation of their potential application as DNA carrier. Journal of Biomaterials Sciences Polymer Edn. 16, 43-56.
Esquisabel, A., R. M. Hernandez, M. Igartua, A. R. Gascón, B. Calvo & J. L. Pedraz, 1997. Production of BCG alginate-PLL microcapsules by emulsification/internal gelation. Journal of Microencapsulation 14, 627-638.
Fasano, A. & S. Uzzau, 1997. Modulation of intestinal tight junctions by zonula occuldens toxin permits enteral administration of insulin and other bioactive macromolecules in an animal model. Journal of Clinical Investigation 99, 1158-1164.
Fujii, S., T. Yokoyama, K. Ikegaya, F. Sato & N. Yokoo, 1985. Promoting effect of the new chymotrypsin inhibitor fk-448 on the intestinal absorption of insulin in rats and dogs. Journal of Pharmacy and Pharmacology 37, 545-549.
Gacesa, P., 1988. Alginates. Carbohydrate Polymers 8, 161-182.
Hashimoto, T., M. Nomoto, K. Komatsu, M. Haga & M. Hayashi, 2000. Improvement of intestinal absorption of peptides: Adsorption of b1-phe monoglucosylated insulin to rat intestinal brush-border membrane vesicles. European Journal of Pharmaceutics and Biopharmaceutics 50, 197-204.
Hashizume, M., T. Douen, M. Murakami, A. Yamamoto, S. Muranishi & et al., 1992. Improvement of large intestinal absorption of insulin by chemical modification with palmitic acid in rats. Journal of Pharmacy and Pharmacology 44, 555-559.
Hinds, K. D., K. M. Campbell, K. M. Holland, D. H. Lewis, C. A. Piche & P. G. Schmidt, 2005. Pegylated insulin in plga microparticles. In vivo and in vitro analysis. Journal of Controlled Release 104, 447-460.
Ho, H. O., C. C. Hsiao & M. T. Sheu, 1996. Preparation of microemulsions using polyglycerol fatty acid esters as surfactant for the delivery of protein drugs. Journal of Pharmaceutical Sciences 85, 138-143.
Hosny, E. A., N. M. K. Ghilzai & A. H. Al-Dhawalie, 1995. Effective intestinal absorption of insulin in diabetic rats using enteric coated capsules containing sodium salicylate. Drug Development and Industrial Pharmacy 21, 1583-1589.
Iwanaga, K., S. Ono, K. Narioka, M. Kakemi, N. Oku & et al., 1999. Application of surface-coated liposomes for oral delivery of peptide: Effects of coating the liposome's surface on the gi transit of insulin. Journal of Pharmaceutical Sciences 88, 248-252.
Iwanaga, K., S. Ono, K. Narioka, K. Morimoto, M. Kakemi, S. Yamashita, M. Nango & N. Oku, 1997. Oral delivery of insulin by using surface coating liposomes: Improvement of stability of insulin in gi tract. International Journal of Pharmaceutics 157, 73-80.
Kim, A., M. O. Yun, Y. K. Oh, W. S. Ahn & C. K. Kim, 1999. Pharmacodynamics of insulin in polyethylene glycol-coated liposomes. International Journal of Pharmaceutics 180, 75-81.
Kimura, T., K. Sato, K. Sugimoto, R. Tao, T. Murak, Y. Kurosaki & T. Nakayama, 1996. Oral administration of insulin as poly(vynil alcohol). Gel spheres in diabetic rats. Biological and Pharmaceutical Bulletin 19, 897-900.
Kreuter, J., 1992. Nanoparticles—preparation and applications. In: M. Donbrow (Editor), Microcapsules and nanoparticles in medicine and pharmacy. CRC Press Boca Raton, Ann Arbor London, London, pp. 125-148.
Lacroix, C., C. Paquin & J.-P. Arnaud, 1990. Batch fermentation with entrapped growing cells of lactobacillus casei; optimization of rheological properties of the entrapment gel matrix. Applied Microbiology Biotechnology 32, 403-408.
Larisch, B. C., D. Poncelet, C. P. Champagne & R. J. Neufeld, 1994. Microencapsulation of lactoccocus lactis subsp. Cremoris. Journal of Microencapsulation 11, 189-195.
Lim, F. & A. M. Sun, 1980. Microencapsulated islets as bioartificial endocrine pancreas. Science 210, 908-910.
Liu, X., W. Xue, Q. Liu, W. Yu, Y. Fu, X. Xiong, X. Ma & Q. Yuan, 2004. Swelling behaviour of alginate-chitosan microcapsules prepared by external gelation or internal gelation technology. Carbohydrate Polymers 56, 459-464.
Liu, X. D., D. C. Bao, W. M. Xue, X. Y., W. T. Yu, X. J. Yu, X. J. Ma & Q. Yuan, 2002a. Preparation of uniform calcium alginate gel beads by membrane emulsification coupled with internal gelation. Journal of Applied Polymer Science 87, 848-852.
Liu, X. D., W. Y. Yu, Y. Zhang, W. M. Xue, W. T. Yu, Y. Xiong, X. J. Ma, Y. Chen & Q. Yuan, 2002b. Characterization of structure and diffusion behaviour of ca-alginate beads prepared with external or internal calcium sources. Journal of Microencapsulation 19, 775-782.
Lowe, P. J. & C. S. Temple, 1994. Calcitonin and insulin in isobutylcyanoacrylate nanocapsules: Protection against proteases and effect on intestinal absorption in rats. Journal of Pharmacy and Pharmacology 46, 547-552.
Magenheim, B. & S. Benita, 1991. Nanoparticle characterization: A comprehensive physicochemical approach. S.T.P. Pharma Sciences 1, 221-241.
Manosroi, A. & J. Manosroi, 1997. Microencapsulation of human insulin DEAE-dextran complex and the complex in liposomes by the emulsion non-solvent addition method. Journal of Microencapsulation 14, 761-768.
Mathiowitz, E., J. S. Jacob, J. Y. S., C. G. P., C. D. E., P. Chaturverdi, C. A. Santos, K. Vijayaraghavan, S. Montgomery, M. Basset & C. Morrel, 1997. Biologically erodable microspheres as potential oral drug delivery systems. Nature 386, 410-414.
Matsuzawa, A., M. Morishita, K. Takayama & T. Nagai, 1995. Absorption of insulin using water-in-oil-in-water emulsion from enteral loop in rats. Biological and Pharmaceutical Bulletin 18, 1718-1723.
McPhillips, A., S. Uraizee, W. Ritschel & A. Sakr, 1997. Evaluation of fluid-bed applied acrylic polymers for the targeted peroral delivery of insulin. S.T.P. Pharma Sciences 7, 476-482.
Mesiha, M., F. Plakogiannis & S. Vejosoth, 1994. Enhanced oral absorption of insulin from desolvated fatty-acid sodium glycocholate emulsions. International Journal of Pharmaceuticals 111, 213-216.
Mesiha, M. & M. Sidhom, 1995. Increased oral absorption enhancement of insulin by medium viscosity hydroxypropyl cellulose. International Journal of Pharmaceuticals 114, 137-140.
Morcol., T., P. Nagappan, L. Nerenbaum, A. Mitchell & S. J. D. Bell, 2004. Calcium phosphate-peg-insulin-casein (capic) particles as oral delivery systems for insulin. International Journal of Pharmaceutics 277, 91-97.
Morishita, I., M. Morishita, K. Takayama, Y. Machida & T. Nagai, 1993a. Enteral insulin delivery by microspheres in 3 different formulations using eudragit 1100 and s100. International Journal of Pharmaceutics 91, 29-37.
Morishita, I., M. Morishita, K. Takayama, Y. Machida & T. Nagai, 1993b. Enteral insulin delivery by microspheres in 3 different formulations using eudragit L-100 and s-100. International Journal of Pharmaceuticals 91, 29-37.
Morishita, M., M. Kajita, A. Suzuki, K. Takayama, Y. Chiba, S. Tokiwa & T. Nagai, 2000. The dose-related hypoglycaemic effects of insulin emulsions incorporating highly purified epa and dha. International Journal of Pharmaceuticals 201, 175-185.
Morishita, M., I. Morishita, K. Takayama, Y. Machida & T. Nagai, 1993c. Site-dependent effect of aprotinin, sodium caprate, na2edta and sodium glycholate on intestinal absorption of insulin. Biological and Pharmaceutical Bulletin 16, 68-72.
Norris, D. A., N. Puri & P. J. Sinko, 1998. Effect of physical barriers and properties on the oral absorption of particulates. Advanced Drug Delivery Reviews 34, 135-154.
Oppenheim, R. C., N. F. Stewart, L. Gordon & H. M. Patel, 1982. Production and evaluation of orally administered insulin nanoparticles. Drug Development and Industrial Pharmacy 8, 531-546.
Pan, Y., Y. Li, H. Zhao, J. Zheng, H. Xu, G. Wei, J. Hao & F. Cui, 2002. Bioadhesive polysaccharide in protein delivery system: Chitosan nanoparticles improve the intestinal absorption of insulin in vivo. International Journal of Pharmaceuticals 249, 139-147.
Patel, H. M. & B. E. Ryman, 1976. Oral administration of insulin by encapsulation within liposomes. FEBS Letters 62, 60-63.
Pelaez, C. & M. Karel, 1981. Improved method for preparation of fruit-simulating alginate gels. Journal of Food Processing and Preservation 5, 63-81.
Pinto-Alphandary, H., 2003. Visualization of insulin-loaded nanocapsules: In vitro and in vivo studies after oral administration to rats. Pharmaceutical Research 20, 1071-1084.
Poncelet, D., 2001. Production of alginate beads by emulsification/internal gelation. Annals of the New York Academy of Sciences 944, 74-82.
Poncelet, D., V. Babak, C. Dulieu & A. Picot, 1999. A physico-chemical approach to production of alginate beads by emulsification-internal ionotropic gelation. Colloids and Surfaces. A: Physiochemical and Engineering Aspects 155, 171-176.
Poncelet, D., R. Lencki, C. Beaulieu, J. P. Halle, R. J. Neufeld & A. Fournier, 1992. Production of alginate beads by emulsification/internal gelation. I. Methodology. Applied Microbiology and Biotechnology 38, 39-45.
Poncelet, D., B. P. D. Smet, C. Beaulieu, M. L. Huguet, A. Fournier & R. J. Neufeld, 1995. Production of alginate beads by emulsification/internal gelation. II. Physicochemistry. Applied Microbiology and Biotechnology 43, 644-650. Provost, H., C. Divies & E. Rousseau, 1985. Continuous production with lactobacillus bulgarius and streptococcus termophillus entrapped in calcium alginate. Biotechnology Letters 7, 247-252.
Quintanar-Guerrero, D., E. Allemann, E. Doekler & H. Fessi, 1998. Preparation and characterization of nanocapsules from preformed polymers by a new process based on emulsification-diffusion technique. Pharmaceutical Research 15, 1056-1062.
Quong, D. & R. J. Neufeld, 1998. DNA protection from extracapsular nuclease, within chitosan- or poly-1-lysine-coated alginate beads. Biotechnology and Bioengineering 60, 124-134.
Quong, D., R. J. Neufeld, G. Skjak-Braek & D. Poncelet, 1998. External versus internal source of calcium during the gelation of alginate beads for DNA encapsulation. Biotechnology and Bioengineering 57, 438-446.
Radwan, M. A., 2001. Enhancement of absorption of insulin-loaded polyisobutylcyanoacrylate nanospheres by sodium cholate after oral and subcutaneous administration in diabetic rats. Drug Development and Industrial Pharmacy 27, 981-989.
Redenbaugh K, P. B., Nichol J W, Kossler M E, Viss P R & W. K A, 1986. Somatic seeds: Encapsulation of assexual plant embryos. Bio/Technology 4, 797-801.
Saez, A., M. Guzman, J. Molpeceres & M. R. Aberturas, 2000. Freeze-drying of polycaprolactone and poly(D,L-lactic-glycolic) nanoparticles induce minor particle size changes affecting the oral pharmacokinetics of loaded drugs. European Journal of Pharmaceutics and Biopharmaceutics 50, 379-387.
Saffran, M., G. S. Kumar, C. Savariar, J. C. Burnham, F. Williams & D. C. Neckers, 1986. A new approach to the oral administration of insulin and other peptide drugs. Science Reports 233, 1081-1084.
Saffran, M., B. Pansky, G. C. Budd & F. E. Williams, 1997. Insulin and the gastrointestinal tract. Journal of Controlled Release 46, 89-98.
Schilling, R. J. & A. K. Mitra, 1990. Intestinal mucosal transport of insulin. International Journal of Pharmaceutics 62, 53-64.
Scott Moncrieff, J. C., Z. Shao & A. K. Mitra, 1994. Enhancement of intestinal insulin absorption by bile salt-fatty acid mixed micelles in dogs. Journal of Pharmaceutical Sciences 83, 1465-1469.
Shah, D. & W.-C. Shen, 1996. Transcellular delivery of an insulin-transferrin conjugate in enterocyte-like caco-2 cells. Journal of Pharmaceutical sciences 85, 1306-1311.
Shao, Z., Y. Li, T. Chermak & A. K. Mitra, 1994. Cyclodextrins as mucosal absorption promoters of insulin. Part 2. Effects of beta-cyclodextrin derivatives on alpha-chymotryptic degradation and enteral absorption of insulin in rats. Pharmaceutical Research 11, 1174-1179.
Shao, Z., Y. Li, R. Krishnamoorthy, T. Chermak & A. K. Mitra, 1993. Differential effects of anionic, cationic, nonionic, and physiologic surfactants on the dissociation, alpha-chymotryptic degradation, and enteral absorption of insulin hexamers. Pharmaceutical Research 10, 243-251.
Shiotani, T. & T. Yamane, 1981. A horizontal packed-bed bioreactor to reduce carbon dioxide gas holdup in the continuous production of ethanol in immobilized yeast cells. European Journal of Applied Microbiology and Biotechnology 13, 96-101.
Silva-Cunha, A., J. L. Grossiord, F. Puisieux & M. Seiller, 1997. W/o/w multiple emulsions of insulin containing a protease inhibitor and an absorption enhancer: Preparation, characterization and determination of stability towards proteases in vitro. International Journal of Pharmaceutics 158, 79-89.
Still, J. G., 2002. Development of oral insulin: Progress and current status. Diabetes Metabolism Research and Reviews 18, S29-S37.
Tin, S. S. H., D. K. Boadi & R. J. Neufeld, 1997. Dna encapsulation by an air-agitated liquid-liquid mixer. Biotechnology and Bioengineering 56, 464-470.
Toft, K., 1982. Interactions between pectins and alginates. Progress in Food Nutritional Science 6, 89-96.
Touitou, E. & A. Rubinstein, 1986. Targeted enteral delivery of insulin to rats. International Journal of Pharmaceutical 30, 95-99.
Tozaki, H., J. Komoike, C. Tada, T. Maruyama, A. Terabe, T. Suzuki, A. Yamamoto & S. Muranishi, 1997. Chitosan capsules for colon-specific drug delivery: Improvement of insulin absorption from the rat colon. Journal of Pharmaceutical Sciences 86, 1016-1021.
Trenktrog, T., B. W. Muller, F. M. Specht & J. Seifert, 1996. Enteric coated insulin pellets: Development, drug release and in vivo evaluation. European Journal Pharmaceutical Sciences 4, 323-329.
Uchiyama, T., T. Sugiyama, Y.-S. Quan, A. Kotani, N. Okada, T. Fujita, S. Muranishi & A. Yamamoto, 1999. Enhanced permeability of insulin across the rat intestinal membrane by various absorption enhancers: Their intestinal mucosal toxicity and absorption-enhancing mechanism of n-lauryl-b-d-maltopyranoside. Journal of Pharmacy and Pharmacology 51, 1241-1250.
Vandenberg, G. W. & J. D. L. Nouè, 2001. Evaluation of protein release from chitosan-alginate microcapsules produced using external or internal gelation. Journal of Microencapsulation 18, 433-441.
Walsh, P. K., F. V. Isdell, S. M. Noone, M. G. O'Donovan & D. M. Malone, 1996. Growth patterns of saccharomyces cerevisiae microcolonies in alginate and carrageenan gel particles: Effect of physical and chemical properties of gels. Enzyme Microbiology Technology 18, 366-372.
Watnasirichaikul, S., T. Rades & I. G. Tucker, 2002. In vitro release and oral bioactivity of insulin in diabetic rats using nanocapsules dispersed in biocompatible microemulsion. Journal of Pharmacy and Pharmacology 54, 473-480.
Xia, C. Q., J. Wang & W. C. Shen, 2000. Hypoglycemic effect of insulin-transferrin conjugate in streptozotocin-induced diabetic rats. Journal of Pharmacology Experimental Therapeutics 295, 594-600.
Yamamoto, A., T. Taniguchi, K. Rikyuu, T. Tsuji, T. Fujita, M. Murakami & S. Muranishi, 1994. Effects of various protease inhibitors on the intestinal absorption and degradation of insulin in rats. Pharmaceutical Research 11, 1496-1500.
Zhang, N., Q. N. Ping, G. H. Huang & W. F. Xu, 2005. Investigation of lectin-modified insulin liposomes as carriers for oral administration. International Journal of Pharmaceutics 294, 247-259.
Ziv, E., M. Kidron, I. Raz, M. Krausz, H. Bar On & et al., 1994. Oral administration of insulin in solid form to nondiabetic and diabetic dogs. Journal of Pharmaceutical Sciences 83, 792-794.

1. Method to encapsulate bioactive macromolecules, into gel polymeric particles sizing less than 10 μm of diameter, and using emulsification/internal gelation comprising the following steps:
a) formation of a water-in-oil emulsion by mixing an aqueous phase which comprises an encapsulating polymer, macromolecule and insoluble salt divalent and gelling agent of said polymer, with oil phase comprising mineral oil and surfactant certain composition, temperature, mechanic stirring rate; and
b) solubilization of insoluble salt of divalent and gelling agent by pH-dependent mechanism follow by gelation of said polymer by reticulation with free divalent ions.

2. Method according to claim 1, wherein the step a) is carried out according to the following sub-steps:
a. 1) dissolution of the encapsulating polymer in distilled water, in adequate concentration, under and orbital agitation and according to predetermined operational settings concerning time, speed rate and temperature;
a.2) addition of macromolecule to the encapsulating polymer in aqueous solution, in adequate concentration, under gentle agitation and according to predetermined operational setting concerning temperature;
a.3) introduction of a mineral oil and a surfactant, liquid state, in adequate concentration and according to predetermined operational setting concerning temperature, into a specific reactor;
a.4) preparation of an external phase, oil phase, containing a mineral oil and a surfactant agent in liquid state, in adequate concentration, under mechanical stirring rate and according to predetermined operational settings concerning time, mechanical stirring rate and temperature, in said reactor;
a.5) preparation of an internal phase, aqueous phase, through the addition of an insoluble salt of divalent ion to the aqueous solution that contains the encapsulating polymer and the macromolecule, in adequate concentration, under gentle and manual agitation and according to predetermined operational settings concerning temperature;
a.6) addition of the aqueous phase into the contained oil phase in the said reactor according to predetermined operational settings concerning time, mechanical stirring rate and temperature;
a. 7) formation of a water-in-oil emulsion resulting from the mixture of an aqueous phase with an oil phase, according to predetermined operational settings concerning time, mechanical stirring rate and temperature;

3. Method according to claim 1, wherein the step b) is carried out according to the following sub-steps:
b.1) the slow addition, drop-by-drop, of an oil soluble organic acid, in adequate concentration, dispersed in a predetermined volume of a mineral oil, into the water-in-oil emulsion.
b.2) solubilization of the divalent ion insoluble salt through a pH-dependent mechanism and according to predetermined operational settings concerning time, agitation speed and temperature; and
b.2) gelation of the encapsulating polymer by ionic cross-linking with free divalent ions according to predetermined operational settings concerning time, mechanical stirring rate and temperature.

4. Method to achieve the subsequent encapsulation of said macromolecules into said polymeric particles, according to claim 1, and recover through partition phases followed by high speed centrifugation cycles, according to the following steps:
c) partition phases of particle-in-oil dispersion by applying a recovery system which comprises acetate buffer solution with predetermined pH with dehydrating agents and a residual oil dissolvent agent in adequate concentration; and
d) high speed centrifugation of said partitioned particle-in-oil dispersion in order to recover part or main part of polymeric particles sizing less than 10 μm.

5. Method according claim 4, wherein the step c) is carried out according to the following sub-steps:
c.1) addition of a recovery system containing acetate buffer solution with predetermined pH with dehydrating agents and a residual oil dissolvent agent, in adequate concentration, into reactor which contains said particle-in-oil dispersion with gelled polymer, in order to produce partition phase of said particle-in-oil dispersion and according to predetermined operational settings concerning time, mechanical stirring rate and temperature;
c.2) transference of said particle-in-oil dispersion, partitioned to a first container of predetermined capacity under orbital agitation in predetermined operational conditions of time, speed rate and temperature;
c.3) settle down the said particle-in-oil dispersion partitioned in the first container in operation conditions predetermined of time and temperature;
c.4) remove by vacuum the said particle-in-oil dispersion, partitioned, to second container of capacity predetermined, followed by addition of acetate buffer solution at predetermined pH, in adequate concentration, and according to predetermined operational conditions temperature;
c.5) transference of polymeric particles sizing less than 10 μm of diameter contained in the first container to one third container of capacity predetermined followed keeping it predetermined temperature.

6. Method according claim 4, wherein the step d) is carried out according to the following sub-steps:
d.1) orbital agitation at predetermined speed rate of said particle-in-oil partitioned with acetate buffer solution at predetermined pH followed by high centrifugalization applying predetermined centrifugal force and predetermined operational conditions predetermined of temperature and time;
d.2) elimination of residual oil by decantation; and
d.3) recovery of polymeric particles by high sped centrifugation, sizing less than 10 μm of diameter containing bioactive macromolecules, and its transference to a third container;
d.4) repeat following procedures: removal by vaccum the top of the partitioned particle-in-oil dispersion, transference of the partitioned particle-in-oil dispersion to the second container with a predetermined capacity; addition of acetate buffer solution in predetermined pH, in adequate concentration; orbital agitation at a predetermined speed rate followed by high speed centrifugation with predetermined centrifuge force, temperature and time until obtaining the total or main part of the polymeric particles sizing less than 10 μm of diameter;
d.5) recovery of the gelled polymeric particles after being centrifuged, sizing less than 10 μm of diameter, containing bioactive encapsulated macromolecules and its transference to a third container; and
d.6) high speed centrifugation of gelled polymeric particles sizing less than 10 μm, containing bioactive encapsulated macromolecules and contained in third container, applying predetermined centrifugal force, and time until all residual oil is removed and particle transference to a fourth container;
d.7) settling of gelled polymeric particles sizing less than 10 μm of diameter and containing bioactive macromolecules, contained in the fourth container, suspended in acetate buffer solution, in adequate concentration, and predetermined pH and according to predetermined operational conditions of temperature.

7. Method in accordance with claim 1, wherein encapsulated macromolecule is a drug.

8. Method in accordance with claim 7, wherein said drug is a peptidic drug.

9. Method in accordance with claim 8, wherein said peptidic drug is insulin with human origin.

10. Method in accordance with claim 1, wherein the polymeric micro- and nanoparticles, spherical sizing less than 10 μm of diameter, are obtained from a linear polymer, of hydrophilic nature and natural origin, selected between oligosaccharides or polysaccharide such as alginic acid and its derivatives, chitin, chitosan and modified chitosan, dextran and modified dextrans dextrins and maltodextrins, pectins and modified pectins agar, agarose, κ- e λ-carrageenans, konjac glucomannan, chondroitin sulfate, xanthan gum, arabic gum, gellan gum, starch and modified starch, cellulose and its derivatives, proteins such as albumin, collagen and gelatin or natural polymer such as rubber and silicas and its derivatives.

11. Method in accordance with claim 10, wherein said polymer is alginate under the sodium salt form.

12. Method in accordance with claim 1, wherein said divalent ion that causes the polymer gelation is calcium under carbonate form.
